(19) United States
(12) Patent Application Publication
(10) Pub. No.: US 2004/0037450 A1
(43) Pub. Date: Feb. 26, 2004

(54) Method, apparatus and system for using computer vision to identify facial characteristics

(76) Inventor: Gary R. Bradski, Palo Alto, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/226,422

(22) Filed: Aug. 22, 2002

(51) Int. Cl. G06K 9/00

(52) U.S. Cl. 382/103

(57) ABSTRACT

A method, apparatus and system identify the location of eyes. Specifically, structured light is transmitted towards an object from a structured light source off the optical axis of a structured light depth imaging device. The light returned from the object to the structured light depth imaging device is used to generate a depth image. In the event the object is a face, contrast areas in the depth image indicate the location of the eyes.

### FIELD OF THE INVENTION

The present invention relates to the field of computer vision. More specifically, the present invention relates to a method, apparatus and system for using computer vision to identify the location of eyes on a face.

### BACKGROUND OF THE INVENTION

Computer vision is being used today in an increasing number of applications. The technology is primarily used in areas such as teleconferencing, surveillance, security, and other similar applications in which identification of a person's facial characteristics is generally desirable. If, for example, a teleconferencing application running on a computer is able to identify the features on a person's face in three dimensions, the application may more accurately target the computer's microphone arrays in the direction of the person's mouth, to better capture and process the person's voice. Alternatively, a security application may capture a facial image and compare the captured image against a database of stored images, to determine an individual's access rights.

The basic premise underlying these applications is the ability to accurately capture and process a three-dimensional (“3D”) facial image without the use of multiple views or special lighting. A standard camera captures two-dimensional (“2-D”) images of objects. There are, however, various cameras that do generate 3-D images of objects. These so-called “depth cameras” from vendors such as 3DV Systems (“3DV”) and Canesta™ capture distance and dimension information for each pixel of a 2-D image. The depth cameras are therefore able to generate a 3-D image or a “depth image” corresponding to the 2-D image. 3DV's camera generates a depth image by integrating a returning wave of pulsed structured light, while Canesta's camera uses the measure of “time of flight” of pulsed structured light to do the same. Depth cameras may also use laser range finders, intensity of returning light, structured light projectors or other such measures to capture and generate 3-D images.

Once a 3-D image is captured, the image is then processed to determine the type of object represented by the image. As described above, computer vision is being increasingly used today in a variety of applications. Many such applications use pattern recognition techniques and/or various software algorithms to identify the location of eyes on a face, and then use the location of the eyes to further identify the locations of other facial features and generate a facial image. The pattern recognition techniques and/or software algorithms used to identify facial features today tend to be light sensitive and/or training set sensitive, and therefore prone to errors.

Thus, for example, although quick and reliable biometric detection systems are highly desirable to identify individuals for various types of access control and/or for security screening purposes, many current iris biometric detection systems use highly unreliable pattern recognition techniques to identify the location of eyes in an individual's face. To improve reliability, some biometric systems may require users to place their eye(s) in a fixed location very close to the camera. This latter technique, although more reliable, is uncomfortable and distressing to individuals who may be reluctant to allow foreign objects so close to their eyes.

### BRIEF DESCRIPTION OF THE DRAWINGS

The present invention is illustrated by way of example and not limitation in the figures of the accompanying drawings in which like references indicate similar elements, and in which:

FIG. 1 illustrates a prior art depth camera transmitting multiple pulses of structured light from a structured light source located on the optical axis of the depth camera towards a face.

FIG. 2 illustrates a face reflecting structured light back in the direction of the structured light source, on the optical axis of the prior art depth camera.

FIG. 3 illustrates the depth image generated by the prior art depth camera.

FIG. 4 illustrates a depth camera transmitting multiple pulses of structured light from a structured light source located off the optical axis of the camera towards a face, according to an embodiment of the present invention.

FIG. 5 illustrates a face reflecting structured light back in the direction of the structured light source, according to an embodiment of the present invention.

FIG. 6 illustrates the depth image generated by the depth camera according to an embodiment of the present invention.

FIG. 7 is a flow chart illustrating how an application may utilize an embodiment of the present invention.

FIG. 8 is a flow chart illustrating further details of one embodiment of the present invention.

FIG. 9 illustrates an imaging system according to one embodiment of the present invention.

### DETAILED DESCRIPTION

The present invention discloses a method, apparatus and system for using computer vision to identify facial characteristics. According to an embodiment, a depth camera is used to generate a depth image of a face that includes an indication of eye locations. More particularly, according to one embodiment, a depth camera having, or coupled to, a structured light source located off the camera's axis is used to generate a depth image containing a contrasting area that indicates the locations of eyes on a face. Once eye locations are identified, various applications may use this information to generate other facial characteristics. Further details of various embodiments of the present invention are described hereafter.

Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

The following description uses a depth camera, such as the camera commercially available from 3DV (known commercially as the “Z-Cam™”), to illustrate embodiments of the present invention. It will be readily apparent to those of ordinary skill in the art, however, that embodiments of the present invention may also be practiced with cameras from other vendors such as Canesta or with any type of depth camera that uses active or structured light to determine depth. The term “structured light” in this specification refers to light having a known structure, including but not limited to: (i) alternating patterns of black and white (or color) that cause black and white (or color) edges to be flashed on the object at large to small scales; (ii) a sharp point or column of light (typically laser light) that scans across a scene; (iii) pulses of light of known duration and timing; and (iv) any other scheme where light is engineered to have a known structure and where knowledge of the structure may be used to extract depth measurements from an illuminated scene. As described above, while 3DV's camera generates a depth image by integrating a returning wave of pulsed structured light, Canesta's camera uses the measure of “time of flight” of pulsed structured light to do the same. Depth cameras may also use laser range finders, intensity of returning light, structured light projectors or other such measures to capture and generate 3-D images.

In summary, depth cameras such as the Z-Cam™ may function as follows. Every 30^{th} of a second, the Z-Cam™ captures a Red, Green and Blue (“RGB”) image of an object, and simultaneously transmits multiple pulses of light from a light source located on the optical axis of the Z-Cam™ towards the object. The Z-Cam then integrates the leading wave front of light reflecting off the objects to obtain depth information for each pixel. This forms a depth image (“D”), which may be combined with the RGB image to yield an “RGBD” image. Any reference in this specification to a “depth image” shall mean an “RGBD image.”

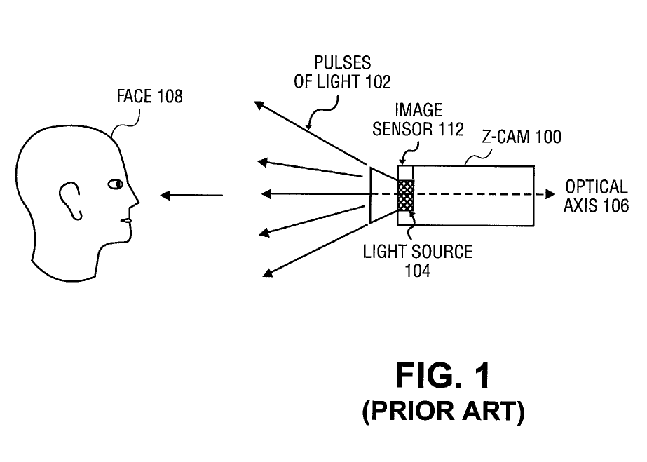

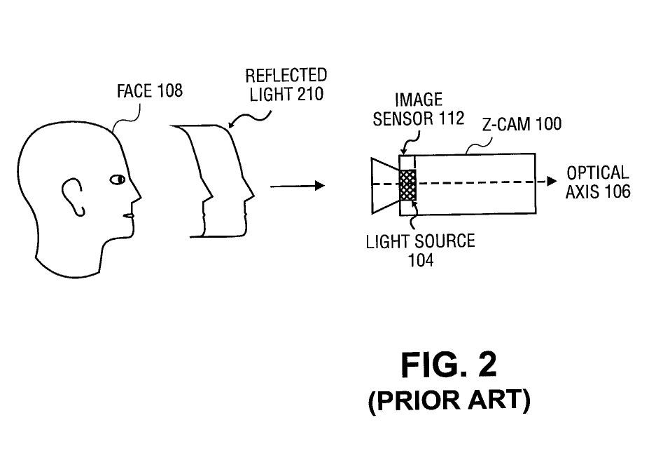

FIGS. 1-3 illustrate this functionality in further detail. Specifically, in FIG. 1, Depth Camera 100 is shown transmitting multiple pulses of structured light 102 (hereafter “light 102”) from a structured light source 104 (hereafter “light source 104”) located on the optical axis 106 of Depth Camera 100 towards an object such as a face 108. Face 108 may reflect light (“reflected light 210”) back in the direction from which it was transmitted, in this case, towards Depth Camera 100, as illustrated in FIG. 2. Depth Camera 100 may activate photon collection on image sensor 112 at a predetermined time. Image sensor 112 may be a Complementary Metal-Oxide Semiconductor (“CMOS”), Charge Control Device (“CCD”) or other such device. Depth Camera 100 may then deactivate its photon collection at a predetermined time. These predetermined activation and deactivation times for photon collection by the image sensor may thus be used to determine the depth range being measured.

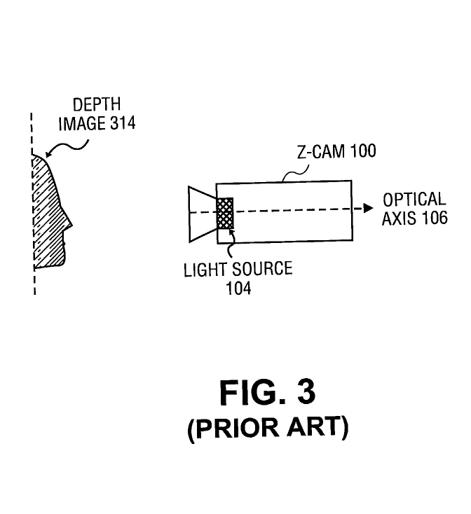

Depth Camera 100 may register the photons from the light pulse collected between the activation and deactivation times as electric charges in each pixel of image sensor 112. On image sensor 112, an analog-to-digital (“A-to-D”) converter may read the collected charge at each pixel. The number of bits available to the A-to-D converter spread out over the photon collection period determines the smallest depth increment that can be measured. Finally, to deal with differential absorption of the light pulses by different materials in the scene, every N^{th} light pulse may be fully integrated and used to set a normalization factor. For example, if light 102 was pulsed at a predetermined width, reflected light 110 may be reflected back in varying widths, depending on the absorption rate. These varying widths may be used to set the normalization factor, which Depth Camera 100 may in turn use to generate depth image 314, as illustrated in FIG. 3.

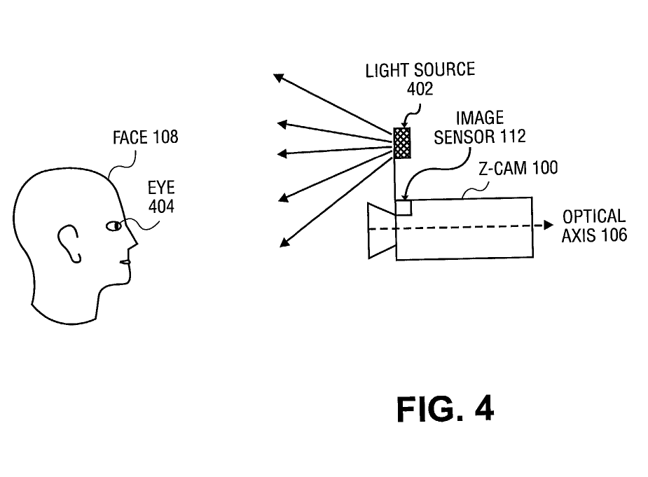

According to one embodiment of the invention, Depth Camera 100 may be modified to accurately identify the location of eyes on a face, or more specifically the pupils of eyes. The terms “eye” and “pupil” are used interchangeably in this specification. As illustrated in FIGS. 4-6, the structured light source of Depth Camera 100 may be moved off the optical axis of the camera and the resulting returned light wave may be used to identify the location of the eyes, as described in further detail below. Although the following description assumes the use of a Z-Cam™ depth camera, it will be readily apparent to one of ordinary skill in the art that other depth cameras and/or imaging systems that employ structured light may also be similarly used to practice embodiments of the invention.

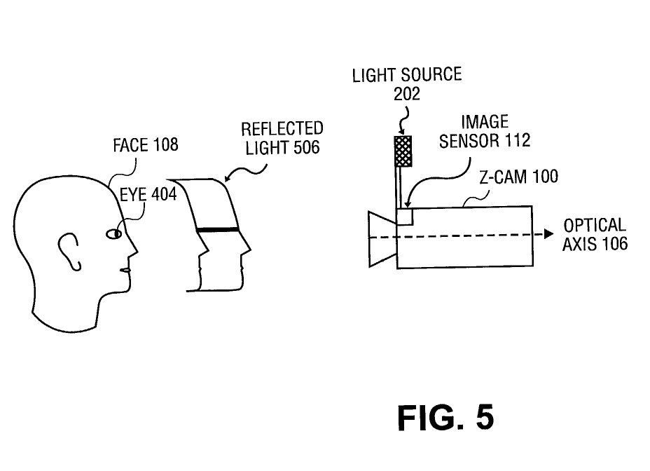

FIG. 4 illustrates structured light source 402 located off the optical axis of Depth Camera 100, according to one embodiment of the present invention. Structured light source 402 may transmit light towards face 108. The light that enters the pupils of eye 404 may be reflected off the retina at the back of eye, and be reflected back to light source 402 (“reflected light 506”), as illustrated in FIG. 5. If the light source is near optical axis 106 of Depth Camera 100, as in FIGS. 1-3 above, most of the light will be reflected off the retina at the back of the eye and be returned to the camera, as illustrated in FIG. 3. According to embodiments of the present invention, however, light source 202 is located off optical axis 106, resulting in reflected light 506 in FIG. 5 being significantly attenuated in the area of eye 404, possibly to the point of being imperceptible. To Depth Camera 100, this reduced and/or lack of returned light results in the pupils appearing to be of infinite (or maximum possible) depth.

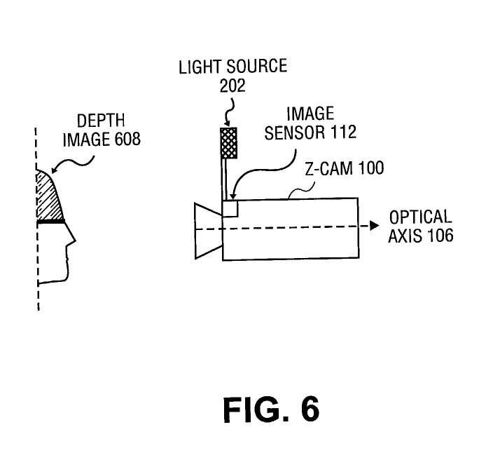

Thus, according to one embodiment of the invention, when Depth Camera 100 integrates the leading half wave front of returning light to yield depth image 608, the eye pupil locations on the face may appear as holes of maximal depth. This maximal depth translates to dark areas in the depth image, as illustrated in FIG. 6. In an alternate embodiment, the eye pupil locations may appear as light areas in a “negative” depth image. In either embodiment, these dark or light areas are “contrast areas,” indicating the location of the eye pupils.

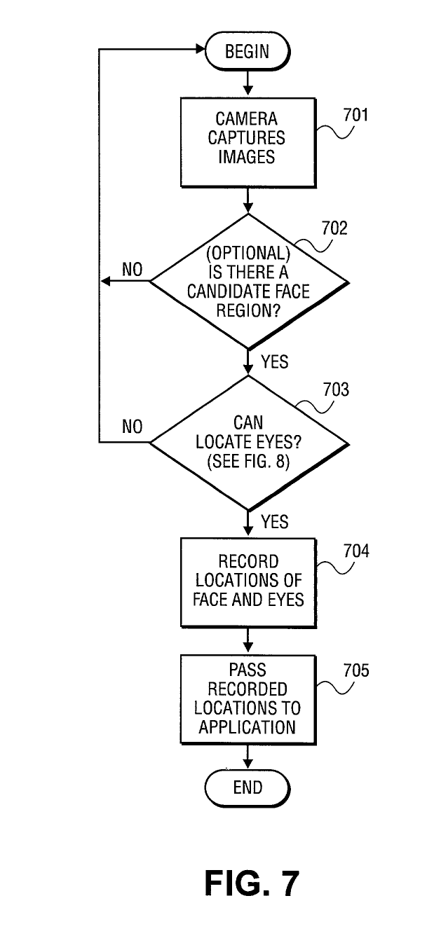

Once the locations of eye pupils are identified, the information may be provided to a variety of applications for use to determine other characteristics of a face. As described above, applications that may benefit from being able to identify the location of the eye pupils include, but are not limited to, teleconferencing applications, surveillance applications, security applications, and other similar applications in which identification of a person's facial characteristics is generally desirable. FIG. 7 is a flow chart of an application using an embodiment of the present invention. In block 701, the depth camera begins capturing 2-D and/or 3-D depth images . According to one embodiment, in block 702, the structured light depth camera may optionally apply pattern recognition techniques (such as boosted decision trees) to the captured images to detect candidate face regions. Pattern recognition techniques encompass a variety of software techniques that are well known in the art and a further description of these techniques is omitted herein in order not to obscure the present invention.

If pattern recognition techniques are applied and face regions are detected in block 702, in block 703 an embodiment of the present invention may be applied to identify the location of eye pupils. Details of block 703 are described in further detail below. If eye locations are identified in block 703, the eyes are deemed to belong to a face and a face is verified in the image. Once a face is verified, in block 704 the locations of the face and eyes in the 2-D and/or 3-D image are recorded. The face and eye location information for the 2-D and/or 3D image(s) may then be passed to an application in block 705. The application may, for example, comprise a face recognition program where the eye locations may be used to align the captured 2-D and/or 3D images to previously stored 2-D and/or 3-D face templates. .

It will be readily apparent to one of ordinary skill in the art that pattern recognition techniques may be applied in certain embodiments to more efficiently process images, eliminating the need to identify the location of eyes if the pattern recognition techniques can conclusively determine that there are no faces in an image. Thus, according to alternate embodiments of the present invention, the structured light depth camera may not apply any pattern recognition techniques to captured images and may instead always attempt to verify facial regions in an image, thus eliminating the need for any other techniques to identify candidate face regions.

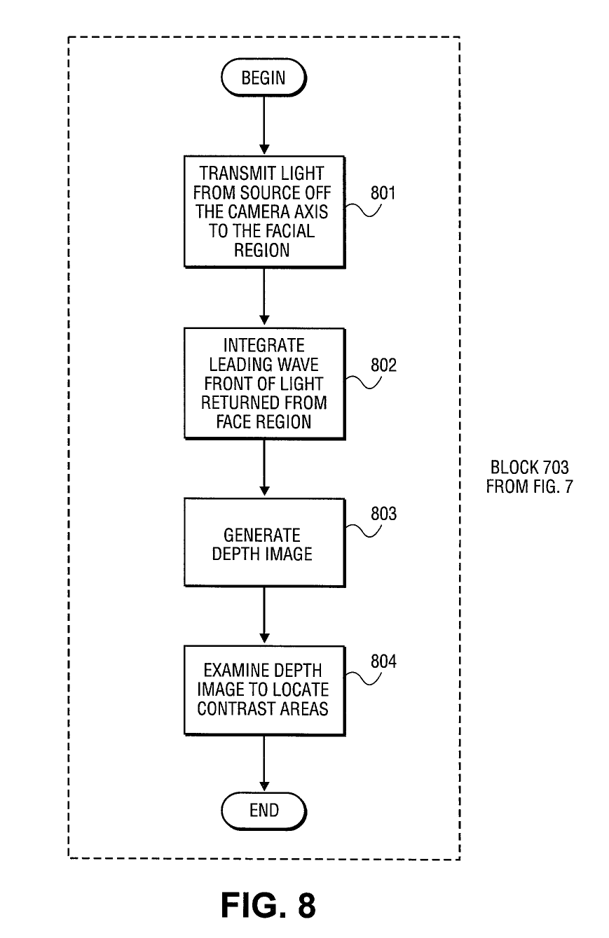

FIG. 8 is a flow chart illustrating further details according to an embodiment of the present invention. More specifically, FIG. 8 expands on the details of block 703 from FIG. 7 above. Specifically, as illustrated in FIG. 8, in block 801 the depth camera transmits light to the face region from a light source off the camera axis. In block 802, the depth camera integrates the leading wave front of pulsed light returned from the face region. The depth camera, in block 803 generates a depth image, and in block 804, the depth image is examined to identify locations of infinite depth, i.e. contrast areas in the image.

Embodiments of the present invention may be implemented with any type of imaging devices that provide functionality similar to currently available depth cameras. These imaging devices may include and/or be coupled to a structured lighting source(s) off the optical axis of the device. Additionally, these devices may include one or more synchronization mechanism(s) between the device and the light source and/or image sensors, graphics chipsets and/or a processor(s). The devices may also include image processing software to work in conjunction with the sensors, chipsets and/or processors. According to one embodiment, a combination of image sensors, graphics chipsets, processors and/or image processing software enable the imaging devices themselves to capture, process and generate 3-D images. According to an alternate embodiment, the imaging devices may include one or more of the above components and be coupled to a computing system and/or other machine capable of executing instructions to achieve the functionality described herein.

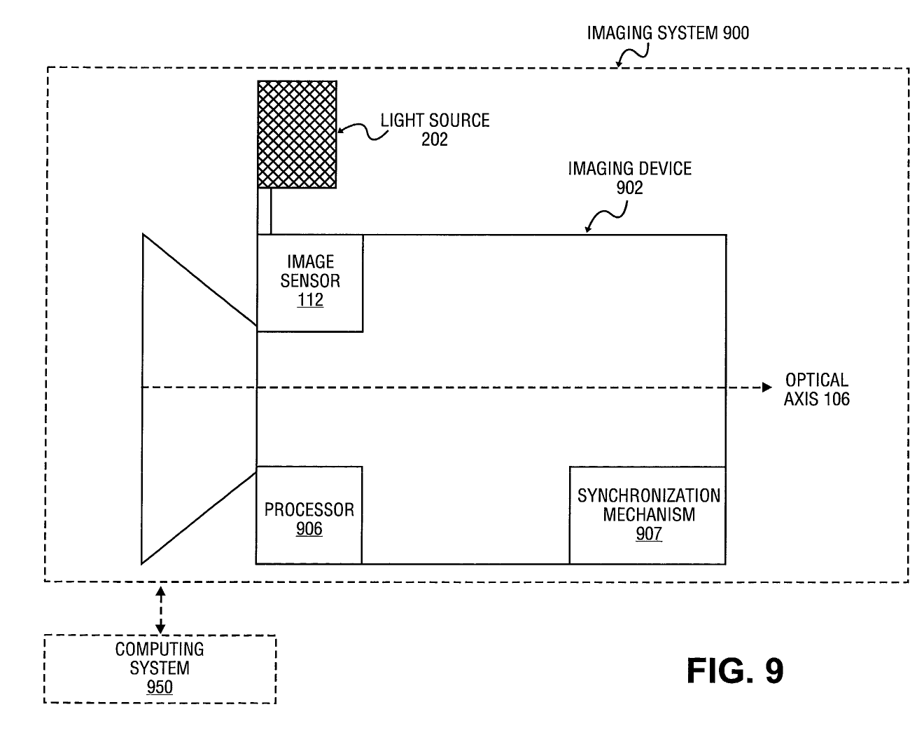

FIG. 9 illustrates an imaging system 900 that may be used to practice embodiments of the present invention. Specifically, as illustrated, imaging system 900 includes imaging device 902. According to one embodiment, imaging device 902 may include image sensor 112, light source 202, synchronization mechanism 904 and processor 906. In alternative embodiments, any and/or all of these components may not be included in imaging device 902 and instead may be coupled to imaging device 902. Synchronization mechanism 904 may be implemented as software, hardware or a combination of software and hardware that are capable of synchronizing imaging device 902 with light source 202. According to one embodiment, imaging system 900 may also include processor 906. Processor 906 may, for example, function as synchronization mechanism 904 or in conjunction with synchronization mechanism 904. It will be readily apparent to one of ordinary skill in the art that synchronization mechanism 904, image sensor 112 and processor 906 may be implemented as discrete components of the system and/or as one or more combined components.

Imaging system 900 may also be coupled to computing system 950, and the combination of these systems may be capable of executing instructions to accomplish an embodiment of the present invention. Computing system 950 may include various well-known components such as one or more processors and various types of memory and/or storage media. The processor(s) and memory/storage media may be communicatively coupled using a bridge/memory controller, and the processor may be capable of executing instructions stored in the memory/storage media. The bridge/memory controller may be coupled to a graphics controller, and the graphics controller may control the output of display data on a display device. The bridge/memory controller may be coupled to one or more buses. A host bus host controller such as a Universal Serial Bus (“USB”) host controller may be coupled to the bus(es) and a plurality of devices may be coupled to the USB. For example, user input devices such as a keyboard and mouse may be included in computing system 950 for providing input data.

In alternate embodiments, imaging system 900 and/or computing system 950 may include a machine coupled to at least one machine-accessible medium. As used in this specification, a “machine” includes, but is not limited to, a computer, a network device, a personal digital assistant, and/or any device with one or more processors. A machine-accessible medium includes any mechanism that stores and/or transmits information in any form accessible by a machine, the machine-medium including but not limited to, recordable/non-recordable media (such as read only memory (ROM), random access memory (RAM), magnetic disk storage media, optical storage media and flash memory devices), as well as electrical, optical, acoustical or other form of propagated signals (such as carrier waves, infrared signals and digital signals).

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method of detecting a location of an eye with a structured light depth imaging device, comprising:
projecting light from a structured lighting source towards a face, the structured lighting source located off an optical axis of the structured light depth imaging device;
receiving the light returned from the face to the structured light depth imaging device; and
generating a depth image from the light returned from the face to the structured light depth imaging device, the depth image including a contrast area indicating the location of the eye.

2. The method according to claim 1 wherein generating the depth image further comprises generating the depth image by integrating a leading wave front of a pulse of the light.

3. The method according to claim 1 wherein generating the depth image further comprises generating the depth image by measuring a time of flight of the light.

4. The method according to claim 1 further comprising applying pattern recognition techniques to identify a candidate face region, and projecting light from the structured lighting source towards the face further comprises projecting light from the structured lighting source towards the candidate face region.

5. The method according to claim 4 wherein receiving the light further comprises receiving the light returned from the candidate face region to the structured light depth imaging device.

6. The method according to claim 1 wherein the structured light depth imaging device comprises a structured light depth camera.

7. A system for detecting a location of an eye on a face, comprising:
a structured light depth imaging device;
a structured lighting source located off an axis of the structured light depth imaging device, the structured lighting source capable of projecting light towards the face and the structured light depth imaging device capable of generating a depth image from the light returned from the face, the depth image including a contrast area indicating the location of the eye; and
a processor capable of synchronizing the structured light depth imaging device with the structured lighting source.

8. The system according to claim 7 wherein the depth image is generated by integrating a leading wave front of a pulse of the light.

9. The system according to claim 7 wherein the depth image is generated by measuring a time of flight of the light

10. The system according to claim 7 wherein the structured light depth imaging device comprises a charge coupled (CCD).

11. The system according to claim 7 wherein the structured light depth imaging device comprises a complementary metal-oxide semiconductor (CMOS) device.

12. The system according to claim 7 wherein the structured light depth imaging device comprises a structured light depth camera.

13. The system according to claim 7 wherein the structured light depth imaging device comprises a camera coupled to a computing system.

14. A structured light depth imaging apparatus for detecting a location of an eye, comprising:
a structured light depth image sensor capable of sensing light returned from the eye, the light being projected towards the eye from a light source off the axis of the apparatus;
a processor capable of processing the light returned from the eye to generate a depth image indicating the location of the eye as a contrast area on the depth map; and
a synchronization mechanism capable of synchronizing signals between the depth image sensor, the light source and the processor.

15. The apparatus according to claim 14 wherein the processor generates the depth image by integrating a leading wave front of a pulse of the light.

16. A method of using a structured light depth imaging device to identify characteristics of a face, comprising:
capturing an image;
applying a pattern recognition technique to the image to detect a candidate facial region;
projecting light from a structured lighting source towards the candidate face region, the structured lighting source located off an optical axis of the depth imaging device;
receiving the light returned from the candidate face region to the structured light depth imaging device; and
generating a depth image from the light returned from the candidate face region to the structured light depth imaging device, the depth image including a contrast area indicating the location of an eye.

17. The method according to claim 16 further comprising transmitting the depth image to an application.

18. The method according to claim 16 wherein the application uses the depth image to generate various characteristics of a face.

19. A method for generating a facial image, comprising:
receiving a depth image generated by a structured light depth imaging device, the structured light depth imaging device coupled to a structured lighting source located off an axis of the structured light depth imaging device, the structured lighting source capable of projecting light towards a face and the structured light depth imaging device capable of generating a depth image from the light returned from the face, the depth image including a contrast area indicating the location of the eye on the face;
processing the depth image to identify the contrast area on the depth image; and
generating the facial image based on the location of the eye.

20. The method according to claim 19 wherein the facial image is sent to one of a security application, a teleconferencing application and a surveillance application.

21. The method according to claim 19 wherein the facial image comprises a three-dimensional facial image.

22. An article comprising a machine-accessible medium having stored thereon instructions that, when executed by a machine, cause the machine to:
project light from a structured lighting source towards a face, the structured lighting source located off an optical axis of a structured light depth imaging device;
receive the light returned from the face to the depth imaging device; and
generate a depth image from the light returned from the face to the structured light depth imaging device, the depth image including a contrast area identifying the location of an eye.

23. The article according to claim 22 wherein the depth image is generated by integrating a leading wave front of a pulse of the light.

24. The article according to claim 22 wherein the depth image is generated by measuring a time of flight of the light.

25. The article according to claim 22 wherein the structured light depth imaging device includes a charge coupled (CCD).

26. The article according to claim 22 wherein the structured light depth imaging device includes a complementary metal-oxide semiconductor (CMOS) device.

27. The article according to claim 22 wherein the structured light depth imaging device is a structured light depth camera.
